(19) United States
(12) Patent Application Publication
(10) Pub. No.: US 2018/0023884 A1
(43) Pub. Date: Jan. 25, 2018

(54) HOUSEHOLD COOLING APPLIANCE INCLUDING A DISPENSING UNIT FOR LIQUIDS AND/OR FREE FLOW REFRIGERATED GOODS WITH A SPECIFICALLY FORMED INSERTION SLOT FOR AN ELECTRONIC MODULE AND HOUSEHOLD COOLING APPLIANCE SYSTEM

(71) Applicant: BSH HAUSGERAETE GMBH, Muenchen (DE)

(72) Inventors: VOLKAN CAKIRCA, ISTANBUL (TR); MEHMET CIYANOGLU, ISTANBUL (TR); TANZER YILDIZGOECER, TEKIRDAG (TR)

(21) Appl. No.: 15/652,305

(22) Filed: Jul. 18, 2017

(30) Foreign Application Priority Data
Jul. 19, 2016 (TR) 2016/09943

(51) Int. Cl. F25D 23/12; F25D 29/00; F25D 23/02; B67D 1/08

(52) U.S. Cl. CPC F25D 23/126; B67D 1/0894; B67D 1/0888; F25D 29/005; F25D 23/028; F25D 2400/361

(57) ABSTRACT

A household cooling appliance includes a dispensing unit for dispensing a liquid and/or free flow refrigerated goods. The dispensing unit includes an insert having walls bounding a recess in which a receiving container can be inserted for receiving the liquid and/or free flow refrigerated goods to be dispensed. A receptacle for an electronic module is formed as a slot having a slot opening bounded by bounding walls. At least one depth stop for the electronic module is formed on at least one of the bounding walls and delimits an installation depth for the electronic module in the direction of a slot axis. A household cooling appliance system is also provided.

### CROSS-REFERENCE TO RELATED APPLICATION

This application claims the priority, under 35 U.S.C. §119, of Turkish Patent Application TR 2016/09943, filed Jul. 19, 2016; the prior application is herewith incorporated by reference in its entirety.

### BACKGROUND OF THE INVENTION

### Field of the Invention

The invention relates to a household cooling appliance including a dispensing unit configured for dispensing a liquid and/or free flow refrigerated goods. The dispensing unit includes an insert having walls bounding a niche. A receiving container can be inserted in the niche for receiving the liquid and/or free flow refrigerated goods to be dispensed. Furthermore, the insert includes a receptacle for an electronic module of the dispensing unit.

Household cooling appliances for storing and preserving food items are known from prior art. It is also known that with such appliances a dispensing unit or an output unit for the liquid and/or free flow refrigerated goods, such as ice cubes or crushed ice, is disposed in a door, which closes a receiving space for food items. Thus, even when the door is closed, dispensing of the liquid or free flow refrigerated goods is possible. A corresponding dispensing unit is known, for example, from International Publication WO 2009/080635 A2, corresponding to U.S. Pat. No. 8,966,927.

Furthermore, International Publication WO 2007/118787 A1, corresponding to U.S. Pat. No. 8,122,734, discloses a household cooling appliance with a corresponding dispensing unit. Moreover, in that appliance, an additional decorative plate, for example a furniture front panel, is disposed separate therefrom on a front side of the door. The furniture front panel has a hole or a recess through which the dispensing unit or a niche of the dispensing unit is also accessible. The dispensing unit in that appliance is also attached to the decorative plate.

Furthermore, a corresponding dispensing unit, which is known from International Publication WO 2009/110674 A1, additionally includes an electronic module. That electronic module includes control elements and furthermore also includes a display unit.

In that known appliance only a very specific electronic module can be mounted to the dispensing unit. If different types of electronic modules are to be installed, as can be the case, for example, in a variant construction of a household cooling appliance, it is then necessary in the prior art to in turn provide different individual dispensing units. Thus, the development effort is high and the diversity of dispensing units to be provided is broad.

### SUMMARY OF THE INVENTION

It is accordingly an object of the invention to provide a household cooling appliance including a dispensing unit for liquids and/or free flow refrigerated goods with a specifically formed insertion slot for an electronic module and a household cooling appliance system, which overcome the hereinafore-mentioned disadvantages of the heretofore-known appliances and systems of this general type, in which the household cooling appliance simplifies the installation of different electronic modules in a dispensing unit and in which the household cooling appliance system enables a correspondingly simplified installation of different electronic modules on different household cooling appliances.

With the foregoing and other objects in view there is provided, in accordance with the invention, a household cooling appliance, including a dispensing unit or an output unit for dispensing a liquid and/or a free flow refrigerated goods. The dispensing unit includes an insert having walls bounding a niche. The niche is a placement niche in which a receiving container, for example a drinking glass or the like, can be placed in order to then be able to carry out filling with the liquid and/or free flow refrigerated goods. This means that the niche is configured for receiving a receiving container in order to then be able to fill-in the liquid and/or free flow refrigerated goods dispensed by the dispensing unit in this inserted state. The dispensing unit further includes a receptacle for an electronic module. The electronic module of the dispensing unit can include control elements and/or a display unit so that settings for operating conditions of the dispensing unit can be set with the help of the control elements or operating functions can be called up. Information regarding the dispensing unit, for example a temperature of the liquid and/or of the free flow refrigerated goods and/or the type of the liquid to be dispensed and/or the type of the dispensable free flow refrigerated goods, can then be displayed on the display unit. Both of the mentioned possibilities which are given by the control elements, and the possibilities of what can be displayed on the display unit, are to be understood only as examples and not as being exhaustive.

An important concept of the invention is to be seen in the fact that the receptacle for the electronic module is formed as a slot having a slot opening which is bounded by bounding walls. At least one depth stop for the electronic module is formed on at least one of these bounding walls, for determining the installation depth for the electronic module in the direction of a slot axis and thus also of the slot opening. Therefore, this means that through the use of the invention a completely defined stop is envisaged so that an electronic module with individual extension can be inserted while fitting exactly in this installation depth direction and is not mounted too deeply in the slot. In particular, an electronic module which because of its individual construction includes a relatively low installation depth can thus also be installed in this slot, without thereby reaching too deeply into the interior of the slot.

Although the basic construction of the slot regarding its slot depth is in particular configured in such a way that an electronic module with larger installation depth can thereby be installed therein, due to this at least one depth stop it is also possible to install an electronic module with a lower installation depth that is different therefrom in this slot and in this connection in particular to be able to position it as desired with regard to the position of the front side of the electronic module.

In particular, it is envisaged that a depth stop with one side facing the slot opening as viewed in the direction of the slot axis ends set back towards the inside relative to the slot opening, in particular is set back by a depth dimension of the electronic module. In this advantageous embodiment, the dimension between this front edge or the front side of the depth stop and the entry of the slot opening measured in the direction of the slot axis is thereby predetermined in such a defined way that the electronic module, which is then to be inserted and delimited towards the back at the depth stop in the installation depth, is positioned correspondingly as desired. In this case it can be envisaged that then a front side of the electronic module is disposed in a defined and desired position relative to a front side of walls of the insert adjacent the slot opening. For example, in this case an aligned configuration can also be envisaged.

Preferably, it is envisaged that the depth stop is formed as a straight bar. It is thereby formed so as to be very small and still mechanically stable.

Preferably, it is envisaged that the bounding wall is a first bounding wall oriented in the direction of the slot axis. Thus, the clear span of the slot opening is not restricted thereby, but by this first bounding wall being framed or circumferentially bordered.

It can be envisaged in an advantageous embodiment that a second bounding wall, which is oriented at an angle relative to the slot axis, ends in the first bounding wall. Due to this embodiment, in which the two bounding walls end preferably perpendicularly relative to each other, then in turn a slot boundary, which correspondingly narrows the opening width of the slot, is formed on a rear end of the slot. Thereby, in particular a higher stability of the bounding walls and thus, also of the slot is reached and due to this specifically oriented second bounding wall then additionally a further depth stop for a different electronic module with a larger installation depth is also provided.

Through the use of the second bounding wall, a width of the slot is reduced, as compared to the first bounding wall.

In an advantageous embodiment the depth stop ends in the second bounding wall. The mechanical stability of the depth stop is then also increased through the use of such a connection, in particular formed in one piece with the bounding wall. In particular, it is then furthermore very advantageous when the depth stop ends in both the first bounding wall and the second bounding wall, in particular when it is formed in one piece with these bounding walls.

In an advantageous embodiment it is envisaged that the whole insert is formed in one piece from plastic material so that the number of components is reduced and the connection of the individual sections towards each other is reached in a mechanically stable way.

Preferably, it is envisaged that at least one first depth stop, in particular at least four, in particular six, depth stops, is formed on a bounding wall which bounds a horizontal longitudinal side of the slot. Additionally, due to this plurality of depth stops on a specific longitudinal side of the slot, an even seating of the electronic module and thus evenness of the stop over the whole extension of the electronic is module is attained. An undesired tilting or slant of the electronic module in the slot is prevented thereby.

In particular, it is envisaged that at least one second depth stop, in particular two depth stops, is formed on a bounding wall which bounds a vertical longitudinal side of the slot. The position accuracy of the electronic module in the final position in the slot is also improved thereby.

With the objects of the invention in view, there is also provided a household cooling appliance system, including a first household cooling appliance which is configured according to one of the above-mentioned embodiments. In this first household cooling appliance a first electronic module with a first module depth is provided and disposed in the slot of the dispensing unit of this first household cooling appliance. This first electronic module has a rear side which contacts the at least one first depth stop, and thereby determines its installation depth in the slot. The household cooling appliance system further includes at least one second household cooling appliance, which is separate from the first household cooling appliance and includes a dispensing unit for dispensing a liquid and/or a free flow refrigerated goods. This dispensing unit, too, includes an insert having walls bounding a niche. A receiving container for receiving the liquid and/or free flow refrigerated goods to be dispensed can be inserted in this niche. This insert, too, includes a receptacle for an electronic module, whereby in this case a second electronic module is to be received. This second electronic module has a second module depth which is larger than the module depth of the first electronic module. The second electronic module is then disposed in the slot of the dispensing unit of the second household cooling appliance and has a rear side which contacts a second bounding wall of the slot reducing a width of the slot and forming a depth stop, so that the installation depth of the electronic module in the slot is thereby determined. It is in particular envisaged that the insert of the dispensing unit of the second household cooling appliance matches the insert of the dispensing unit of the first household cooling appliance. However, it does not include the at least one or several depth stops. In this insert of the second dispensing unit of the second household cooling appliance, the insertion depth of the second electronic module is not delimited by these depth stops but by the second bounding wall which then in this case forms the respective depth stop for the second electronic module.

In general, this second bounding wall extends across the whole length of a first bounding wall and is in particular formed without interruption.

In the first household cooling appliance the local depth stop, which is formed on a bounding wall, is configured as a locally very limited element which is significantly smaller than the first bounding wall and/or the second bounding wall in the respective directions of extension. This first depth stop in the dispensing unit of the first household cooling appliance is therefore a quasi physical element in addition to the bounding walls and thus in addition to the first and the second bounding walls. Such an additional element is not provided in the embodiment of the second household cooling appliance.

With the help of a very simple and small modification of the insert, namely only by the presence of at least one bar-shaped or pin-shaped depth stop in addition to the bounding walls, a simple manufacture of these variants of the inserts is also possible, and all further features, in particular the further dimensions, can remain the same for both inserts.

With the objects of the invention in view, instead of or in addition to the embodiments described above, there is concomitantly provided a household cooling appliance system including a first household cooling appliance of the invention or a preferred embodiment thereof, in which a first electronic module is disposed in the slot and contacts the at least one depth stop with a rear side and thereby has its installation depth in the slot determined. The first household cooling appliance includes a first cover with a first thickness (measured in the depth direction of the insert) at least partly covering a front side of the insert of the dispensing unit, and a front side of the electronic module is flush with a front side of the first cover. The household cooling appliance system includes at least one second household cooling appliance with a dispensing unit according to the first household cooling appliance, however, without the depth stop, in which a first electronic module is disposed in the slot of the dispensing unit of the second household cooling appliance and has a rear side contacting a second bounding wall of the slot forming a depth stop and reducing a width of the slot and thereby determined its installation depth in the slot. The second household cooling appliance includes a second cover with a second thickness at least partly covering a front side of the insert of the dispensing unit, and a front side of the electronic module is flush with a front side of the second cover. Therefore, both household cooling appliances have flush front sides, independently of the electronic modules having different thicknesses and/or the covers having different thicknesses.

Preferably, the household cooling appliance is a rack-mounted-model. It could especially be disposed in a furniture niche of a furniture wall.

The terms “top,” “bottom,” “front,” “rear,” “horizontal,” “vertical,” “depth direction,” “width direction,” “height direction,” etc. indicate the positions and orientations for intended use and intended configuration of the appliance and for a viewer looking in the direction of the device.

Further features of the invention are derived from the claims, the figures, and the description of the figures. The features and feature combinations previously mentioned in the description as well as the features and feature combinations mentioned in the following description of the figures and/or shown in the figures alone can be used not only in the respectively indicated combination, but also in other combinations, without departing from the scope of the invention. Thus, embodiments of the invention are also to be considered as being included and disclosed which are not explicitly shown and explained in the figures, but are derived through separate feature combinations from the embodiments which are explained and can be generated therefrom. Embodiments and feature combinations are also to be considered as being disclosed which do not have all of the features of an originally formulated independent claim. Moreover, explanations and feature combinations are to be considered as being disclosed, in particular by the embodiments set out above, which go beyond the feature combinations set out in the references to the claims or deviate therefrom.

Other features which are considered as characteristic for the invention are set forth in the appended claims.

Although the invention is illustrated and described herein as embodied in a household cooling appliance including a dispensing unit for liquids and/or free flow refrigerated goods with a specifically formed insertion slot for an electronic module and a household cooling appliance system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, exploded, perspective view of an example of an embodiment of a household cooling appliance according to the invention;

FIG. 2 is a perspective view of an insert of a first dispensing unit;

FIG. 3 is a perspective view of an insert of a dispensing unit of a second household cooling appliance;

FIG. 4 is an enlarged, fragmentary, perspective view of the embodiment of the insert according to FIG. 2;

FIG. 5 is an enlarged, fragmentary, perspective view of the insert according to FIG. 3;

FIG. 6 is a vertical-sectional view of parts of a first household cooling appliance of a household cooling appliance system; and

FIG. 7 is a vertical-sectional view of parts of a second household cooling appliance of the household cooling appliance system.

### DETAILED DESCRIPTION OF THE INVENTION

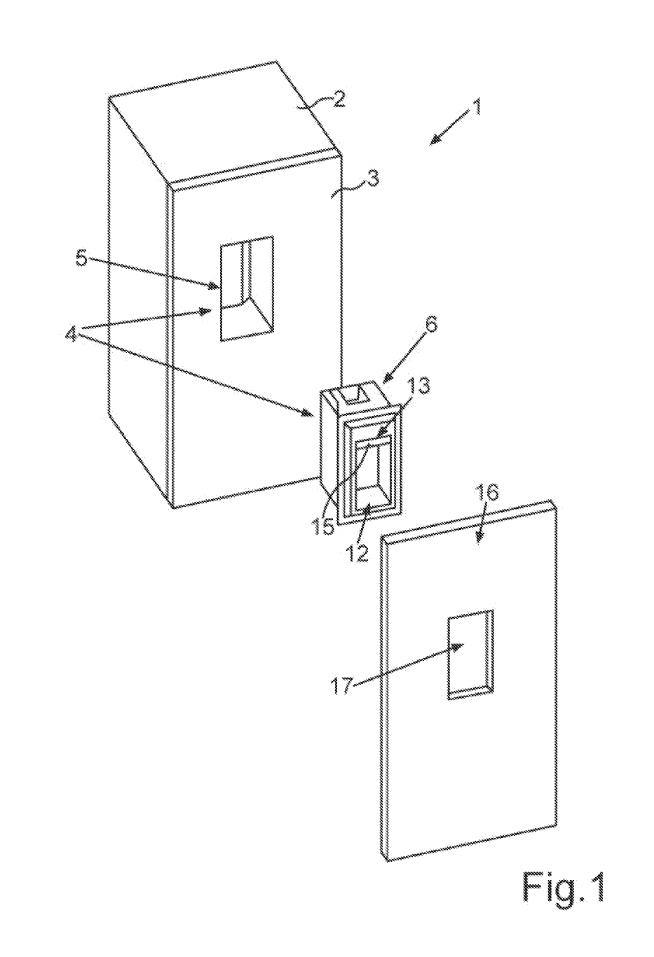

Referring now in detail to the figures of the drawings, in which the same elements and elements having the same function are equipped with the same reference signs, and first, particularly, to FIG. 1 thereof, there is seen a diagrammatic view of a household cooling appliance 1 which, for example, can be a cooling appliance, a freezer or a refrigerator-freezer combination device. In particular, the household cooling appliance 1 is a rack-mounted-model. The household cooling appliance 1 includes a housing 2, in which at least one receiving space for food items is provided. This receiving space can be closed from the front by a door 3, which in FIG. 1 is shown in closed state and which is disposed pivotably at the housing 2. The household cooling appliance 1 includes a dispensing unit which is only shown in an exemplarily manner, which is provided with reference sign 4 in FIG. 1 and in which individual components are only partially shown. The dispensing unit 4 is configured for dispensing a liquid and/or free flow refrigerated goods. For this purpose, in the illustrated embodiment, the door 3 includes a recess 5, in which the dispensing unit 4 is inserted, so that in a closed state of the door 3 the dispensing unit 4 is accessible from the front, in order to be able to dispense the liquid and/or the free flow refrigerated goods.

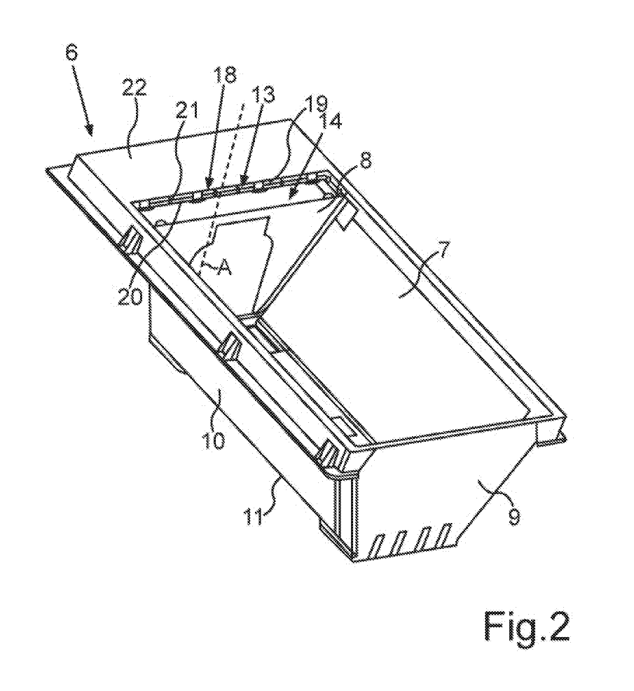

The dispensing unit 4 includes an insert 6, which in particular is formed in one piece from plastic material. The insert 6 includes several walls 7, 8, 9, 10, and 11 (FIG. 2), which bound a niche 12. The recess or the niche 12 is configured for receiving or for inserting a receiving container so that the liquid and/or the free flow refrigerated goods to be dispensed can then be inserted in the receiving container.

The insert 6 further includes a receptacle 13, which is configured as slot 14 (FIG. 2). An electronic module 15, which is shown symbolically and in a simplified manner in FIG. 1, can be inserted in the receptacle 13.

Furthermore, FIG. 1 also shows a decorative plate 16, which is preferably provided separately from the door 3 and which can be a furniture front panel. This decorative plate 16 can preferably be mounted to the door 3 and covers it from the front. This decorative plate 16 also includes a recess 17 through which the dispensing unit 4 is accessible from the front. In particular, the dispensing unit 4, especially the insert 6, is disposed on the decorative plate 16, in particular mounted thereto.

FIG. 2 shows the insert 6 in a perspective view. It can be seen that the slot 14 includes a front slot opening 18, which is bounded by bounding walls.

In the illustrated embodiment first bounding walls 19 are provided, which extend in the direction of a slot axis A and thereby also determine the slot depth which is measured in the direction of this slot axis A. In the illustrated embodiment second bounding walls 20 are further provided, which end in the first bounding walls 19, but are disposed at an angle relative thereto, in particular at an angle of 90° relative thereto. The second bounding walls 20 are therefore in a vertical position relative to the slot axis A and thereby reduce the width of the slot 14. This means that as compared to the front slot opening 18, the width of the slot in the configuration of the second bounding walls 20, which is set backwards, is larger.

It is further envisaged that a plurality of depth stops 21 is provided in the insert 6 according to FIG. 2. In the embodiment example the depth stops 21 are formed in one piece with the first bounding walls 19 and the second bounding walls 20. The depth stop 21 determines the installation depth for the electronic module 15 which is measured in the direction of the slot axis A and thereby delimits this installation depth.

In the embodiment according to FIG. 2, it is therefore possible to install an electronic module 15 which has a lower module depth and due to the depth stops 21 can therefore be positioned accordingly towards a front side 22 of the insert 6.

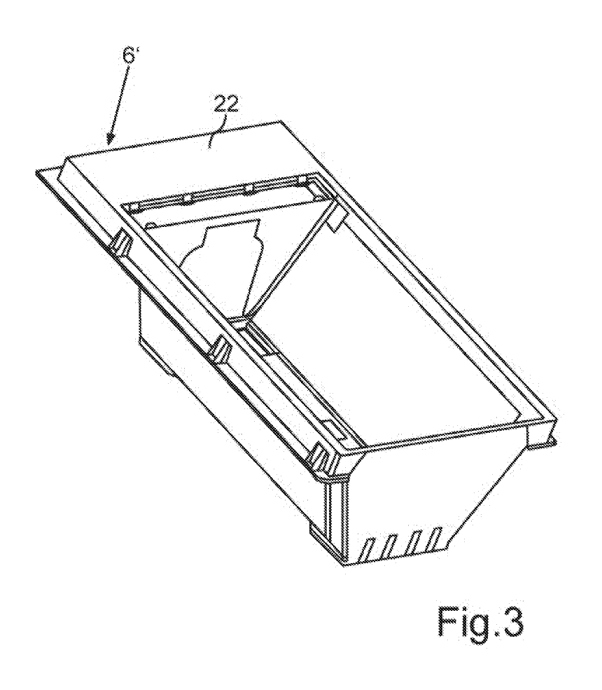

FIG. 3 shows an embodiment of an insert 6′ in which, in contrast to the embodiment according to FIG. 2, the depth stops 21 are not provided, but which otherwise is in particular provided in structural conformity with the insert 6.

Therefore, reference may be made to FIG. 2 with respect to the respective reference signs. The reference signs are not provided again in FIG. 3 for reasons of clarity.

In the insert 6′, in contrast to the insert 6, a second electronic module which has a larger module depth than the electronic module 15 which is installed in the insert 6 according to FIG. 2, can therefore be installed in the slot 14. In the embodiment of the insert 6′ the second bounding wall 20 then serves as a depth stop so that in the mounted final position when viewing from the front, the respective electronic modules are disposed in the same position towards the front sides 22, although they have different module depths and therefore reach into the respective slots 14 to different extents.

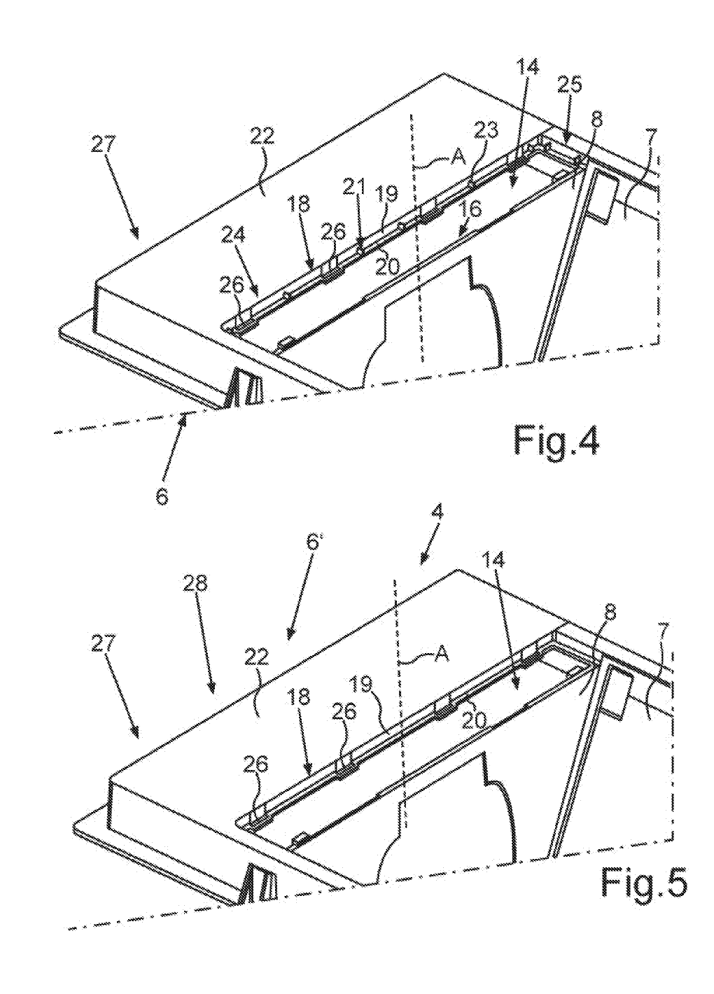

FIG. 4 shows an enlarged view of the insert 6 in the region of the slot 14. The respective depth stops 21 can be seen in more detail therein.

In FIG. 4 it can also be seen that a front side 23 of a depth stop 21, which faces the slot opening 18 and thus the opening of the slot 14, as viewed in the direction of the slot axis A, ends in a set back towards the inside relative to the slot opening 18. In particular, it is set back by a depth dimension of the respective electronic module 15 to be inserted.

In contrast thereto, FIG. 5 shows an enlarged view of the insert 6′ in the region of the slot 14. It can be seen in this case that the depth stops 21 are not provided.

As can also be seen in FIG. 4, several depth stops 21 are disposed at different respective sides, whereby in this case for example on a longitudinal side 24, which is oriented horizontally, six such depth stops 21 are disposed as an example, and on a vertical longitudinal side 25 two such depth stops 21 are disposed, although in this case only one of these two depth stops can be seen on the longitudinal side 25 in FIG. 4.

It can then also be seen in the embodiments that in the second bounding walls 20 passages 26 are formed, only some of which are equipped with corresponding reference signs. Connecting elements of the respective electronic module can be led through these passages 26, in order to be able to mount or fix the respective electronic module.

Furthermore, FIGS. 4 and 5 show an embodiment of a household cooling appliance system 27, in which only the different inserts 6 and 6′ of the different household cooling appliances 1 and 28 are partly shown. The household cooling appliance system 27 includes a first household cooling appliance 1 with the insert 6 in which a first electronic module 15 could be inserted with a first depth of the module and which is disposed in the slot 14 and which contacts the at least one depth stop 21 with a rear side and which is thereby determined regarding its installation depth in the slot 14.

The household cooling appliance system 27 includes at least one second household cooling appliance 28 with a dispensing unit 4 according to the first household cooling appliance 1, but without depth stops 21. The dispensing unit 4 receives a second electronic module with a second depth of the module that is larger than the depth of the module of the first electronic module 15 and which is disposed in the slot 14 of the dispensing unit 4′ of the second household cooling appliance 28 and with a rear side contacts a second bounding wall 20 of the slot 14 forming a depth stop and reducing a width of the slot 14 and which is thereby determined regarding its installation depth in the slot 14.

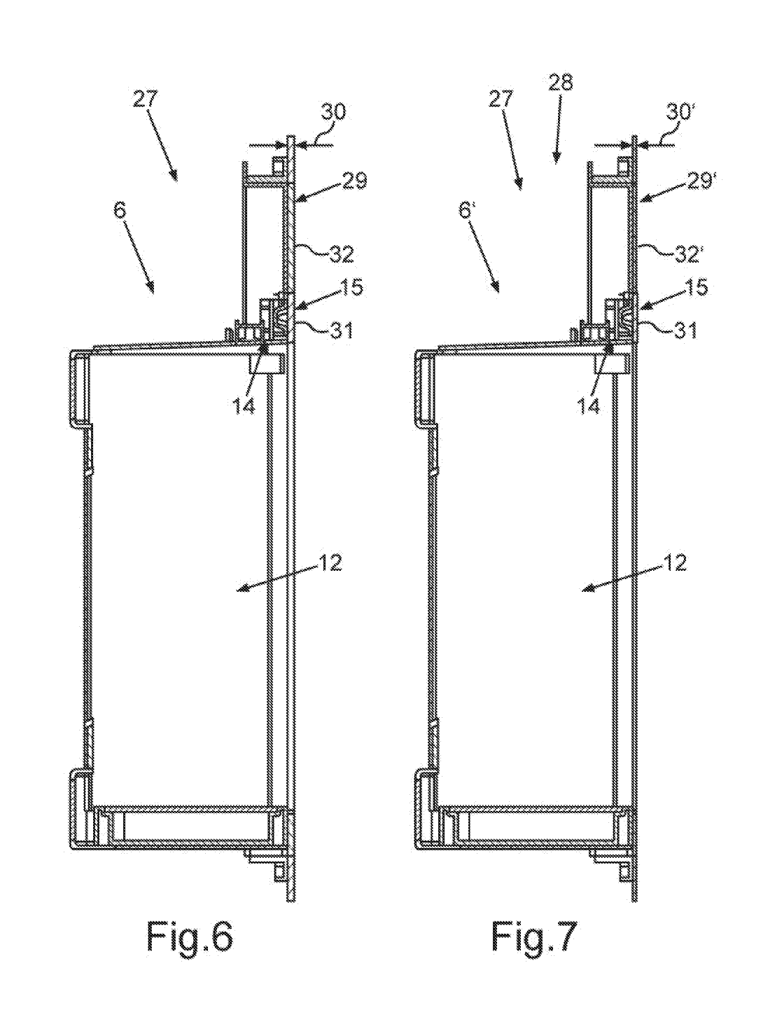

In another embodiment preferably the household cooling appliance 1 includes a cover 29 as a part which is separate from the insert 6. The cover 29 at least partly covers the front side of the insert 6, especially in the region of the slot 14. As can be seen in FIG. 6, which is a sectional view of parts of the first household cooling appliance 1, the cover 29 has a thickness 30. Preferably, a front side 31 of the electronic module 15 is flush with a front side 32 of the cover 29. This is achieved because of the at least one depth stop 21.

A preferred embodiment a cover 29′ is provided in FIG. 7, which is a sectional view of parts of the second household cooling appliance 28. The difference as compared to the cover 29 is that the thickness 30′ of the second cover 29′ is less than the thickness 30 of the first cover 29. The same electronic modules 15 are mounted with this embodiment of the household cooling appliance system 27 in both household cooling appliances 1 and 28 and therefore electronic modules 15 with the same depth are mounted. Due to the smaller thickness 30′ it is not necessary to have depth stops 21 in the slot 14 of the insert 6′ to achieve a flush position of the front sides 32′ and 31.

The embodiments with different depths of the electronic modules 15 on one side and with different thicknesses 30, 30′ of the covers 29, 29′ on the other side could be combined, so that preferably front sides 31 of the electronic modules 15 and front sides 32, 32′ of the covers 29, 29′ are flush in both household cooling appliances 1 and 28 of the household cooling appliance system 27.

Preferably, covers are disposed in the embodiments described with reference to FIG. 4 and FIG. 5, too. It is possible for the covers to be equal for both household cooling appliances 1 and 28 or for the covers to be different, especially regarding their thicknesses.

1. A household cooling appliance, comprising:
a dispensing unit for dispensing at least one of a liquid or free flow refrigerated goods, said dispensing unit including an insert;
said insert having walls bounding a recess in which a receiving container can be inserted for receiving the at least one of liquid or free flow refrigerated goods to be dispensed; and
a receptacle for an electronic module, said receptacle being formed as a slot having bounding walls and a slot axis, said bounding walls bounding a slot opening, and said receptacle having at least one depth stop formed on at least one of said bounding walls for delimiting an installation depth of the electronic module in a direction of said slot axis.

2. The household cooling appliance according to claim 1, wherein said at least one depth stop has one side facing said slot opening in said direction of said slot axis, said one side ending in a set back towards an inside relative to said slot opening.

3. The household cooling appliance according to claim 2, wherein said set back is equal to a depth dimension of the electronic module.

4. The household cooling appliance according to claim 1, wherein said at least one depth stop is formed as a straight bar oriented in said direction of said slot axis.

5. The household cooling appliance according to claim 1, wherein one of said bounding walls in which said at least one depth stop ends is a first bounding wall oriented in said direction of said slot axis.

6. The household cooling appliance according to claim 5, wherein another of said bounding walls is a second bounding wall ending in said first bounding wall, said second bounding wall being oriented at an angle relative to said slot axis.

7. The household cooling appliance according to claim 6, wherein said angle is 90°.

8. The household cooling appliance according to claim 6, wherein said second bounding wall delimits a reduced width of said slot as compared to a width of said slot delimited by said first bounding wall.

9. The household cooling appliance according to claim 6, wherein said second bounding wall ends in said at least one depth stop.

10. The household cooling appliance according to claim 1, wherein one of said bounding walls bounds a horizontal longitudinal side of said slot, and said at least one first depth stop includes at least four or six depth stops formed on said one bounding wall.

11. The household cooling appliance according to claim 1, wherein one of said bounding walls bounds a vertical longitudinal side of said slot, and said receptacle has at least one second depth stop or two second depth stops being formed on said one bounding wall.

12. A household cooling appliance system, comprising:
a first household cooling appliance including:
a first dispensing unit for dispensing at least one of a liquid or free flow refrigerated goods, said first dispensing unit including a first insert having walls bounding a first recess in which a receiving container can be inserted for receiving the at least one of liquid or free flow refrigerated goods to be dispensed;
a first receptacle being formed as a first slot having first bounding walls and a first slot axis, said bounding walls bounding a first slot opening, and said first receptacle having at least one first depth stop formed on at least one of said first bounding walls; and
a first electronic module having a first depth, being disposed in said first slot and having a rear side contacting said at least one first depth stop for determining an installation depth of said first electronic module in said first slot in a direction of said first slot axis; and
at least one second household cooling appliance including:
a second dispensing unit for dispensing at least one of a liquid or free flow refrigerated goods, said second dispensing unit including a second insert having walls bounding a second recess in which a receiving container can be inserted for receiving the at least one of liquid or free flow refrigerated goods to be dispensed;
a second receptacle being formed as a second slot having second bounding walls and a second slot axis, said second bounding walls bounding a second slot opening; and
a second electronic module having a second depth being larger than said first depth, being disposed in said second slot and having a rear side contacting one of said second bounding walls of said second slot forming a second depth stop, reducing a width of said second slot and determined an installation depth of said second electronic module in said second slot in a direction of said second slot axis.

13. A household cooling appliance system, comprising:
a first household cooling appliance including:
a first dispensing unit for dispensing at least one of a liquid or free flow refrigerated goods, said first dispensing unit including a first insert having a front side and having walls bounding a first recess in which a receiving container can be inserted for receiving the at least one of liquid or free flow refrigerated goods to be dispensed;
a first receptacle being formed as a first slot having first bounding walls and a first slot axis, said bounding walls bounding a first slot opening, and said first receptacle having at least one first depth stop formed on at least one of said first bounding walls;
a first electronic module being disposed in said first slot, having a front side and having a rear side contacting said at least one first depth stop for determining an installation depth of said first electronic module in said first slot in a direction of said first slot axis; and
a first cover having a first thickness at least partly covering said front side of the insert, said first cover having a front side being flush with said front side of said electronic module; and
at least one second household cooling appliance including:
a second dispensing unit for dispensing at least one of a liquid or free flow refrigerated goods, said second dispensing unit including a second insert having a front side and having walls bounding a second recess in which a receiving container can be inserted for receiving the at least one of liquid or free flow refrigerated goods to be dispensed;
a second receptacle being formed as a second slot having second bounding walls and a second slot axis, said second bounding walls bounding a second slot opening;
a second electronic module being disposed in said second slot, having a front side and having a rear side contacting one of said second bounding walls of said second slot forming a second depth stop, reducing a width of said second slot and determining an installation depth of said second electronic module in said second slot in a direction of said second slot axis; and
a second cover having a second thickness at least partly covering said front side of said second insert, said second cover having a front side being flush with said front side of said second electronic module.
